(19) United States
(12) Patent Application Publication
(10) Pub. No.: US 2010/0206094 A1
(43) Pub. Date: Aug. 19, 2010

(54) Device and Method for Sample Collection and Concentration

(75) Inventor: Alexander Shenderov, Raleigh, NC (US)

Correspondence Address: ADVANCED LIQUID LOGIC, INC.;C/O WARD AND SMITH, P.A., 1001 COLLEGE COURT, P.O. BOX 867, NEW BERN, NC, 28563-0867, US

(73) Assignee: ADVANCED LIQUID LOGIC, INC., Research Triangle Park, NC (US)

(21) Appl. No.: 12/596,898

(22) PCT Filed: Apr. 23, 2008
(86) PCT No.: PCT/US08/61223

§ 371 Date: Feb. 16, 2010

Related U.S. Application Data
(60) Provisional application No. 60/913,385, filed on Apr. 23, 2007.

(51) Int. Cl. G01N 1/22

(52) U.S. Cl. 73/863.21; 422/255

(57) ABSTRACT

An apparatus and a method for concentrating a target substance in a liquid has been invented. The apparatus comprises a first reservoir with inlet openings for introducing a fluid comprising a target substance into the first reservoir and a second reservoir separated from the first reservoir by a partition permeable to permit the fluid to traverse the partition while retaining the target substance in the first reservoir.

### 1 BACKGROUND

As methods of analysis require smaller and smaller input samples, there is a need in the art for approaches to preparing small samples from large samples sources. One such issue is the preparation of small samples including particulates from larger fluid samples, such as gas samples or liquid samples.

### 2 DESCRIPTION

The invention provides an analyte capture and concentration device. The device is useful for capturing target analytes from a gaseous source, such as air, and concentrating the analytes into a small volume of liquid for subsequent analysis. Among other things, concentration of analytes improves sensitivity and speed of analysis. The device is useful for capturing and concentrating a wide variety of analytes, such as chemical and/or biological analytes. The device can work with little or no requirement for power and is easy to use in field settings.

### 2.1 ANALYTE CAPTURE AND CONCENTRATION DEVICE

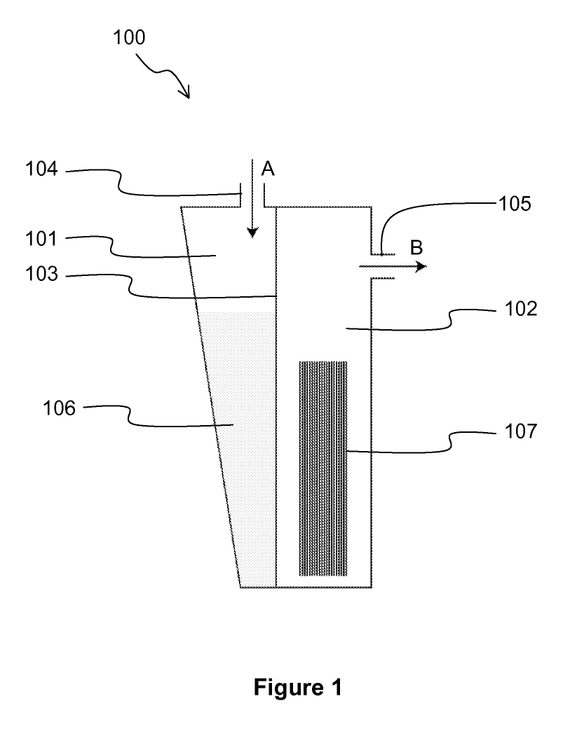

As illustrated in FIG. 1, in one embodiment, the device includes a multi-chambered reservoir 100. The reservoir generally includes a sample collection chamber 101 separated from an absorbent chamber 102 by means of a filter 103. Absorbent chamber 102 may include an absorbent material 107. The sample collection chamber 101 and/or the absorbent chamber 102 may include volume markings for facilitating operator control of liquid volumes in these chambers.

The device also includes ports 104 and 105 for flowing air through the chambers during operation. The ports 104 and 105 serve as inlets and outlets for gaseous source materials. Port 104 may serve as an intake port, and port 105 may serve as an outflow port. One or more pressure or vacuum sources may be fluidly coupled to ports 104 and/or 105 to facilitate flow of gaseous samples through the chambers. In one embodiment, it is a large rectangular opening which facilitates flow of gaseous sample, such as air, through the port. The device may include caps, plugs or other coverings having suitable shapes and characteristics for sealing the openings 104 and 105. The intake port 104 may include a mesh covering to prevent introduction of larger contaminants or particles into the sample collection chamber 101. For example, a mesh size may be selected to filter out particulates that are larger than particulates expected to contain the analyte of interest.

During operation the flow of gaseous source material may be as follows: into the reservoir 100 through the inlet port 104, through the sample collection chamber 101, through the filter 103, through the absorbent chamber 102, and out of the device through the outlet port 105. The target analyte is captured by the filter 103, which is positioned in this flow path between the sample collection chamber 101 and the absorbent chamber 102. During operation, fluid 106 may be present in sample collection chamber 101.

In operation, gas is flowed through the flow path, and target analyte is retained in the sample collection chamber 101 by the filter 103. A washing liquid 106 is added into the sample collection chamber to wash the target analyte from the filter. Washing may be enhanced in some cases, e.g., by mechanical agitation, manual shaking, and the like to aid in separating analyte from the filter 103. The washing liquid may be selected to traverse the filter 103 into the absorbent chamber 102, where it may be absorbed by an absorbent material 107. As the washing liquid 106 traverses the filter 103, the volume of washing liquid in the sample collection chamber 101 is reduced, and the concentration of analyte is increased. In some embodiments, the sample collection chamber 101 may be tapered, e.g., as illustrated in FIG. 1, such that the area of a horizontal cross-section of the sample collection chamber 101 is smaller at the bottom and larger at the top. Such an arrangement facilitates concentration of analyte into a smaller sample as the washing liquid 106 is absorbed by the absorbent material 107.

Optional caps or other coverings may be provided to seal the ports 104 and 105 when not in use. Further, input port may include a filter to screen out unwanted substances, such as large particulates.

### 2.2 ANALYTE CAPTURE AND CONCENTRATION DEVICE WITH TEST STRIP CHAMBER

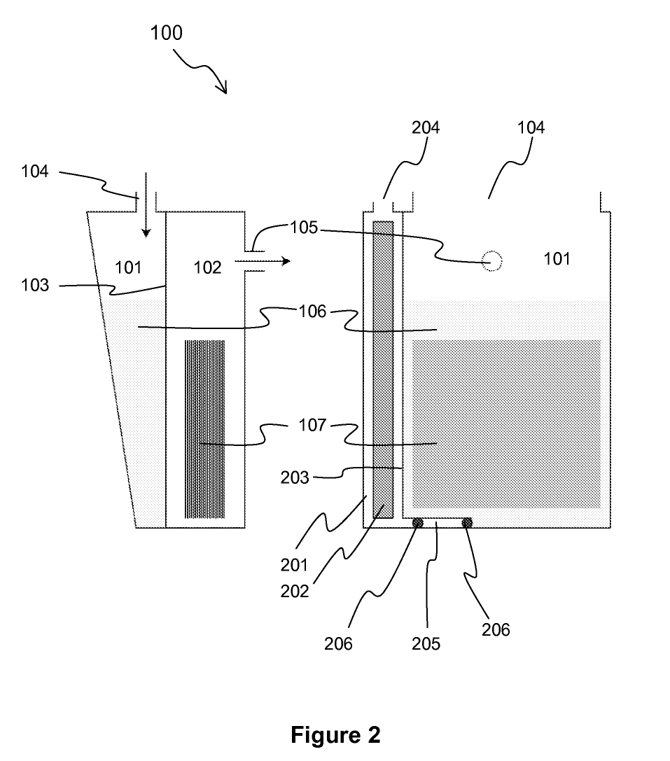

FIG. 2 shows a cross section of the sample collection chamber 101 including a test strip chamber. In addition to the elements described with respect to FIG. 1, the figure illustrates an optional test strip chamber 201 for insertion of a test strip 202. The test strip chamber 201 is separated from the sample collection chamber by barrier 203. A valved fluid path 205 couples the sample collection chamber 101 to the test strip chamber 201. In the specific embodiment illustrated in FIG. 2, the valved fluid path comprises soft plastic tubing with one or more ball valves 206.

In an alternative embodiment, the device of the invention may be used to concentrate an analyte present in a liquid sample. In this embodiment, the port 105 is not necessary. Liquid sample may be added to sample collection chamber 101, where it traverses filter 103 into the absorbent chamber 102, where it is absorbed by absorbent material 107, leaving behind in the sample collection chamber 101 a liquid with an increased concentration of the target analyte.

### 2.3 ANALYTE CAPTURE AND CONCENTRATION DEVICE WITH CONICAL FILTER

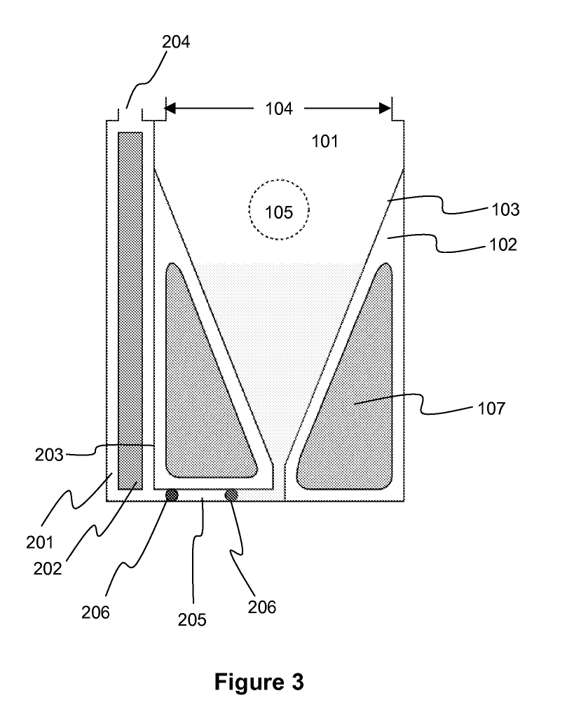

FIG. 3 illustrates another embodiment of the invention in which the filter 103 is generally cone shaped, forming a generally cone shaped sample collection chamber 101, surrounded by the absorbent chamber 102. As described with respect to FIG. 2, a fluid path 205 fluidly couples the sample collection chamber 101 with the test strip chamber 201.

### 2.4 MULTIPLE DEVICE ASSEMBLY

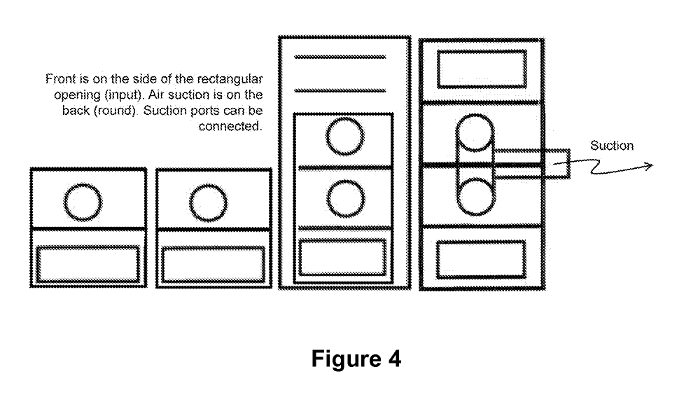

FIG. 4 illustrates an aspect of the invention in which an assembly includes multiple sample collection and concentration devices of the invention. Any number of the units can be used together. Two-piece combinations are shown in top view. The back-to-back combination does not require any base support or legs. Back-to-back modification allows interconnection of all suction connectors and uses individual units for gas sampling, by choice, of opening of an individual piece.

### 2.5 MATERIALS

It will be appreciated that a wide variety of materials may be employed to achieve the purposes of the invention. Suitable examples are described in the ensuing sections.

2.5.1 Absorbent Material

The type and amount of absorbent material is selected to permit the desired amount of liquid to be absorbed. The absorbent may be recyclable. The absorbent chamber 102 may include an opening for introduction of the absorbent material 107 into the absorbent chamber 102. The absorbent may be provided in any suitable form, including without limitation, sheet, foams, paper-like absorbents, granulated absorbents, spongy absorbents, etc. In general, absorbents are preferably secured to prevent granules from escaping from the absorbent chamber. Granulated absorbents may be secured in a permeable enclosure, such as an inert mesh-like material. The absorbent may fill part or all of the absorbent chamber 102 and may be attached to the chamber walls, embedded in the filter 103 and/or one or more of the chamber walls may be manufactured using the absorbent material.

2.5.2 Filter

The filter 103 may be a filter and/or membrane assembly selected to preferentially retain analytes of interest in the sample collection chamber. In one embodiment, the filter 103 is an aerosol filter. The membrane cut-off molecular weight and pore size are selected to capture the target analyte and with a view to facilitating the desired analysis. In one embodiment, the filter 103 comprises an upper region which has a large pore size for capturing aerosols and a lower region with a small pore size for capturing proteins and viruses, e.g., an upper filter region made from ISOPORE™ filter media with a pore size of 0.8 microns, and a lower ultrafiltration membrane with a cut-off molecular weights of 7,500 Da (pore size is about 2-3 nm). The filter media may, for example, be a hydrophobic plastic material. The ISOPORE™ portion serves as a low-size air particulate cut-off filter. It is positioned in the upper portion of the reservoir 100 adjacent to the exit port 105. The low molecular weight filter permits liquid to pass into the absorbent chamber 102 where it can be absorbed, thereby leaving behind a more concentrated sample. The filter media can include supports, e.g., rib-like structures or grid structures to maintain the position and/or shape of the filter 103 inside the device.

2.5.3 Reservoir Materials

Materials are selected based on intended use, and should be sufficiently chemically and/or biologically inert that they do not unduly interfere with the intended use. Reservoir body 100 may, for example, be manufactured using transparent acrylic plastic. Caps may, for example, be rubber-like plastic. Tubing may, for example, be tygon tubing. It will be appreciated that a wide variety of alternative materials will be suitable.

2.5.4 Test Strips

Any of a variety of analytical techniques may be employed using concentrated samples of the invention. In one embodiment, the analytical technique involves the use of a test strip. Analysis using a test strip can be conducted using a separate strip or a strip associated with the structure of the disclosed device. In one embodiment, the concentrated sample is analyzed by immunochromatography, using a test strip that is either inserted into the device after the concentration step or is an integral part of the device, mounted on the device itself.

For collecting and processing an aerosol sample using a test strip, this device may be coupled to the inlet of a deflator, and aerosol particles may be collected on the aerosol filter. A wash solution may be added. The ports may be closed, and the device may be shaken to provide agitation. The device may then be maintained in a horizontal position while washing liquid traverses the filter and absorbs into the absorbent material. In the preferred method of use, the appropriate port is opened, and an immunochromatographic test strip is inserted through it into the concentrated sample. After the process of immunochromatography has completed, the strip is (optionally) removed from the device and read either visually or using an appropriate reader.

If the device is used for test-strip analysis, the test paper strip can be inserted through port 104 into the sample collection chamber as a dipstick with visual control of the result. As an alternative, a separate test strip chamber 201 may be provided, e.g., as described above with respect to FIG. 2.

One or more test strips can be provided for analysis of one or more analytes. The device may include storage for any additional required reagents. For example, reagents can be stored in the fluid path 205, shown in FIG. 2. A second valve 206 can be included to retain the reagent in the fluid path 205 prior to initiation of the analytical procedure.

2.5.5 Base and Packaging

A base or other support, such as side legs or balancing extensions, may be included to maintain the device in an upright position during use. The device of the invention may be provided as a single use, disposable, and self-contained article of manufacture. Appropriate packaging and instructions for use according to the method of the invention may also be included.

### 2.6 Analytes

A wide variety of analytes may be concentrated using the sample concentration device of the invention. Examples of suitable analytes are chemical and biological analytes.

### 3 REFERENCES

The entire disclosures of the following references are incorporated herein by reference:
1. E. M. Zepilivan, W. H. Blatt, and H. H. Loeffler (1974) U.S. Pat. No. 3,817,379 “Disposable Liquid Concentrating Device”, filed Jul. 10, 1972.
2. V. Vissarotti (2002) U.S. Pat. No. 6,372,144 “Method for Concentrating or Washing macromolecules in a solution and Device for Carrying out said Method”, filed Jun. 7, 1995, foreign application priority date Jun. 13, 1994.
3. V. Vissarotti (2005) U.S. Pat. No. 6,837,995 “Device for Concentrating and Purifying Macromolecules”, filed Feb. 8, 2000, foreign application priority date Feb. 15, 1999.
4. Gregory D. Wight. Fundamentals of Air Sampling. 1994: CRC Press, Boca Raton, Fla.

I claim:

1. An apparatus for concentrating a target substance in a liquid, the apparatus comprising:
(a) a first reservoir comprising one or more inlet openings for introducing a liquid comprising a target substance and for flowing a gaseous source material comprising the target substance into the first reservoir; and
(b) a second reservoir separated from the first reservoir by a partition sufficiently permeable to permit the liquid to traverse the partition while retaining the target substance in the first reservoir.

2. The apparatus of claim 1 wherein the first reservoir is substantially horizontally adjacent to the second reservoir.

3. The apparatus of claim 1 wherein the partition is substantially vertically oriented between the first reservoir and the second reservoir.

4. The apparatus of claim 1 further comprising an absorbent material in the second reservoir selected to absorb the liquid.

5. The apparatus of claim 1 further comprising one or more outlet openings in the first and/or second reservoir for flowing the gaseous source material out of the apparatus.

6. The apparatus of claim 1 wherein the one or more inlet openings is positioned such that the gaseous source material is introduced directly into the liquid.

7. The apparatus of claim 1 wherein the one or more inlet openings is positioned such that the gaseous source material is introduced into the atmosphere above the liquid.

8. The apparatus of claim 1 further comprising a third reservoir separated from the first reservoir by a liquid flow path controlled by a valve.

9. The apparatus of claim 8 wherein the flow path fluidly couples a bottom region of the first reservoir with a bottom region of the third reservoir.

10. The apparatus of claim 1 wherein the first fluid reservoir is conically shaped having an apex oriented in a generally downward direction.

11. A target substance collection assembly comprising an arrangement of apparatuses of claim 1 coupled together.

12. A method of concentrating a target substance from a gaseous source material into a liquid sample, the method comprising:
(a) providing an apparatus for concentrating a target substance in a liquid, the apparatus comprising:
(i) a first reservoir comprising one or more inlet openings for introducing a liquid comprising a target substance and for flowing a gaseous source material comprising the target substance through the first reservoir; and
(ii) a second reservoir separated from the first reservoir by a partition sufficiently permeable to permit the liquid to traverse the partition while retaining the target substance in the first reservoir;
(b) flowing a liquid into the first reservoir;
(c) flowing gaseous source material comprising the target substance into the first reservoir and into contact with the liquid, thereby permitting the target substance to be transferred from the gaseous source material into the liquid;
(d) flowing a portion of the liquid across the partition while retaining at least a portion of the target substance in the first reservoir, thereby concentrating the target substance in the first reservoir.

13. The method of claim 12 wherein the first reservoir is substantially horizontally adjacent to the second reservoir.

14. The method of claim 12 wherein the partition is substantially vertically oriented between the first reservoir and the second reservoir.

15. The method of claim 12 further comprising absorbing liquid in an absorbent material in the second reservoir.

16. The method of claim 12 further comprising flowing the gaseous source material out of the apparatus via one or more outlet openings in the first and/or second reservoir.

17. The method of claim 12 wherein the one or more inlet openings is positioned such that the gaseous source material is introduced directly into the liquid.

18. The method of claim 12 wherein the one or more inlet openings is positioned such that the gaseous source material is introduced into the atmosphere above the liquid.

19. The method of claim 12 further comprising flowing liquid comprising concentrated target substance through a liquid flow path into a third reservoir comprising a test strip.

20. The method of claim 19 wherein the flow path fluidly couples a bottom region of the first reservoir with a bottom region of the third reservoir.

21. The method of claim 12 wherein the first fluid reservoir is conically shaped having an apex oriented in a generally downward direction.
